(19) United States
(12) Patent Application Publication
(10) Pub. No.: US 2025/0246811 A1
(43) Pub. Date: Jul. 31, 2025

(54) ELECTRONIC DEVICE

(71) Applicant: Lenovo (Beijing) Limited, Beijing (CN)

(72) Inventor: Shirong YANG, Beijing (CN)

(21) Appl. No.: 19/033,382

(22) Filed: Jan. 21, 2025

(30) Foreign Application Priority Data
Jan. 31, 2024 (CN) 202410140078.7

(51) Int. Cl. H01Q 5/335; H01Q 1/24; H01Q 21/06

(52) U.S. Cl. CPC H01Q 5/335; H01Q 1/243; H01Q 21/06

(57) ABSTRACT

An electronic device includes a target antenna. The target antenna includes a first radiator, a second radiator, a third radiator, a transceiver, and a plate representing ground. The first radiator includes a feed point. The second radiator includes a first ground point and has a first gap with the first radiator. The third radiator includes a second ground point, is located in the first gap between the second radiator and the first radiator, and divides the first gap into a first slit and a second slit. The transceiver is connected to the feed point. The plate representing ground is connected to the first ground point and the second ground point. The target antenna supports a radio frequency (RF) signal of a first frequency and an RF signal of a second frequency, and the first frequency is different from the second frequency.

### CROSS-REFERENCE TO RELATED APPLICATION

The present disclosure claims priority to Chinese Patent Application No. 202410140078.7, filed on Jan. 31, 2024, the entire content of which is incorporated herein by reference.

### TECHNICAL FIELD

The present disclosure is related to the wireless communication technology field and, more particularly, to an electronic device having an antenna.

### BACKGROUND

A main apparatus for an electronic device to realize its communication function is an antenna. In the electronic device, to support communication standards of different operators, the antenna needs to operate at a plurality of frequency bands. Meanwhile, an electronic device with a Multiple-Input Multiple-Output (MIMO) function requires more antennas to be integrated. Thus, each antenna needs to have a small volume and a large operation bandwidth.

### SUMMARY

An aspect of the present disclosure provides an electronic device, including a target antenna. The target antenna includes a first radiator, a second radiator, a third radiator, a transceiver, and a plate representing ground. The first radiator includes a feed point. The second radiator includes a first ground point and has a first gap with the first radiator. The third radiator includes a second ground point, is located in the first gap between the second radiator and the first radiator, and divides the first gap into a first slit and a second slit. The transceiver is connected to the feed point. The plate representing ground is connected to the first ground point and the second ground point. The target antenna supports a radio frequency (RF) signal of a first frequency and an RF signal of a second frequency, and the first frequency is different from the second frequency.

### BRIEF DESCRIPTION OF THE DRAWINGS

FIG. 1 illustrates a schematic structural diagram showing a circuit connection relationship of an electronic device according to some embodiments of the present disclosure.

FIG. 2 illustrates a schematic diagram showing a top view of a conductor of an electronic device according to some embodiments of the present disclosure.

FIG. 3 illustrates a schematic enlarged diagram of a dashed-line box in FIG. 2.

FIG. 4 illustrates a schematic structural diagram of a target antenna of FIG. 3 in another view angle.

FIG. 5 illustrates a schematic structural diagram of a target antenna of FIG. 3 in another view angle.

FIG. 6 illustrates a schematic structural diagram of a target antenna in a first view angle according to some embodiments of the present disclosure.

FIG. 7 illustrates a schematic structural diagram of a target antenna in a second view angle according to some embodiments of the present disclosure.

FIG. 8 illustrates a schematic structural diagram of a target antenna in a third view angle according to some embodiments of the present disclosure.

FIG. 9 illustrates a schematic equivalent circuit diagram of a target antenna according to some embodiments of the present disclosure.

FIG. 10 illustrates a schematic equivalent circuit diagram of another target antenna according to some embodiments of the present disclosure.

FIG. 11 illustrates a schematic diagram showing a return wave loss of a target antenna according to some embodiments of the present disclosure.

FIG. 12 illustrates a schematic diagram showing radiation efficiency of a target antenna according to some embodiments of the present disclosure.

### REFERENCE NUMERALS

| | | |
|---|---|---|
| GND1 - First ground point | GND2 - Second ground point | F -Feed point |
| 100 - Target antenna | 101 - First radiator | 102 - Second radiator |
| 103 - Third radiator | 104 - First gap | 105 - First slit |
| 106 - Second slit | 107 - Transceiver | 108 - Plate |
| 109 - Second gap | 110 - First structure | 111- Second structure |
| 112 - Connector | 113 - Third structure | 114 - Fourth structure |
| L_{R} - First inductor | L_{L} - Second inductor | C_{L} - First capacitor |
| C_{R} - Second capacitor | | |

### DETAILED DESCRIPTION OF THE EMBODIMENTS

Embodiments of the present disclosure are described in detail in connection with the accompanying drawings of embodiments of the present disclosure. Apparently, the described embodiments are merely some embodiments of the present disclosure, not all embodiments. Based on embodiments of the present disclosure, all other embodiments obtained by those skilled in the art without creative efforts shall be within the scope of the present disclosure.

To make the objectives, features, and advantages of the present disclosure clearer, the present disclosure is further described in detail in connection with the accompanying drawings and specific embodiments.

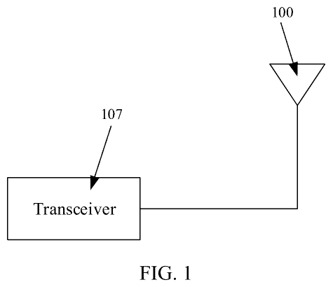

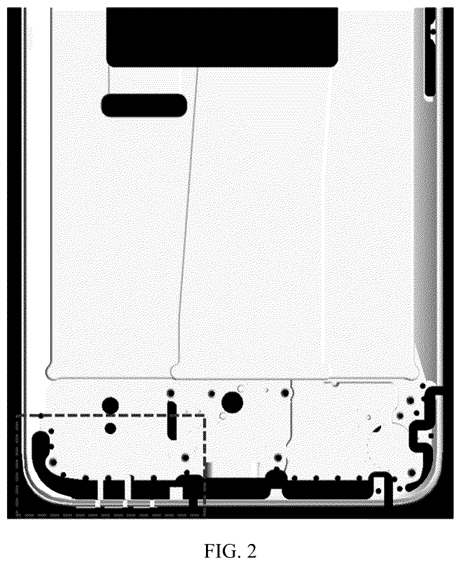

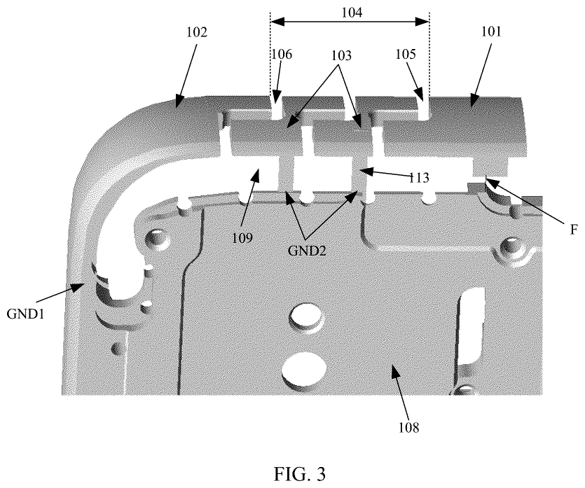

As shown in FIG. 1 to FIG. 3, FIG. 1 illustrates a schematic structural diagram showing a circuit connection relationship of an electronic device according to some embodiments of the present disclosure. FIG. 2 illustrates a schematic diagram showing a top view of a conductor of an electronic device according to some embodiments of the present disclosure. FIG. 3 illustrates a schematic enlarged diagram of a dashed-line box in FIG. 2. The electronic device includes a target antenna 100. A part of a conductor of the electronic device can be used as the target antenna 100.

The target antenna 100 includes a first radiator 101, a second radiator 102, a third radiator 103, a transceiver 107, and a plate 108 representing ground.

The first radiator 101 includes a feed point F. The second radiator 102 includes a first ground point GND1. The second radiator 102 and the first radiator 101 have a first gap 104. The third radiator 103 includes a second ground point GND2. The third radiator 103 is arranged in the first gap 104 between the second radiator 102 and the first radiator 101. The third radiator 103 divides the first gap 104 into a first slit 105 and a second slit 106. The transceiver 107 is connected to the feed point F. The plate 108 representing the ground is connected to the first ground point GND1 and the second ground point GND2.

The target antenna 100 can support a radio frequency (RF) signal of a first frequency and an RF signal of a second frequency. The first frequency can be different from the second frequency.

In the electronic device of embodiments of the present disclosure, the target antenna 100 can generate resonance through the third radiator 103 to increase the bandwidth. A relatively large communication bandwidth can be formed based on a radiator with a relatively small volume and can be at least used to receive and transmit the RF signal of the first frequency and the RF signal of the second frequency.

In the circuit connected to the target antenna 100, the transceiver 107 can be directly connected to the feed point F or connected to the feed point F based on the RF circuit, which is not limited here.

In some embodiments, as shown in FIG. 3, the third radiator 103 and the plate 108 representing the ground have a second gap 109 there between. In embodiments of the present disclosure, the radiator of the antenna is divided into a first radiator 101, a second radiator 102, and at least one third radiator 103. The third radiator 103 is connected to the plate 108 representing the ground based on the second ground point GND2. The third radiator 103 and the plate 108 representing the ground have the second gap 109. Thus, the target antenna 100 can generate resonance based on the third radiator 103. The third radiator 103 can generate a better resonant effect when the target antenna 100 has the first frequency and the second frequency.

In embodiments of the present disclosure, as shown in FIG. 3, the structure of the first radiator 101 at the first slit 105 matches with the structure of the third radiator 103 at the first slit 105. The first slit 105 has a non-straight line structure. The structure of the second radiator 102 at the second slit 106 matches the structure of the third radiator 103 at the second slit 106. The second slit 106 has a non-straight line structure.

The first radiator 101 and the second radiator 102 each can have the structure matching the structure of the third radiator 103 on the opposite side. Thus, the third radiator 103 can generate a better resonant effect at the first frequency and the second frequency of the target antenna 100. Moreover, the first slit 105 and the second slit 106 with the non-straight line structures can be used to enhance the resonant effect of the third radiator 103 at the first frequency and the second frequency of the target antenna 100.

In embodiments of the present disclosure, the target antenna 100 can include N third radiators 103. N is an integer. As shown in FIG. 3, for example, N=2. Thus, the value of N can be correspondingly set based on the communication needs of the target antenna. N can be one or more than one, which is not limited here.

In the target antenna 100, if N is greater than 1, the N third radiators 103 can have identical structures and can be sequentially arranged. The N third radiators 103 can divide the first gap 104 into N+1 slits. The N third radiators 103 each can have a second gap 109 with the plate 108 representing ground.

The N third radiators 103 can have an identical structure and can be sequentially arranged in a direction of the connection line between the first radiator 101 and the second radiator 102. In addition, the N third radiators 103 can divide the first gap 104 into the N+1 slits. Thus, the first radiator 101 can have a slit (i.e., a first slit 105) with the third radiator 103. The second radiator 102 can have a slit (i.e., a second slit 106) with the third radiator 103. The neighboring third radiators 103 can have a slit. The N third radiators 103 each can have the second gap 109 with the plate 108 representing ground. Then, the N third radiators 103 can generate a good resonant effect at the first frequency and the second frequency corresponding to the target antenna.

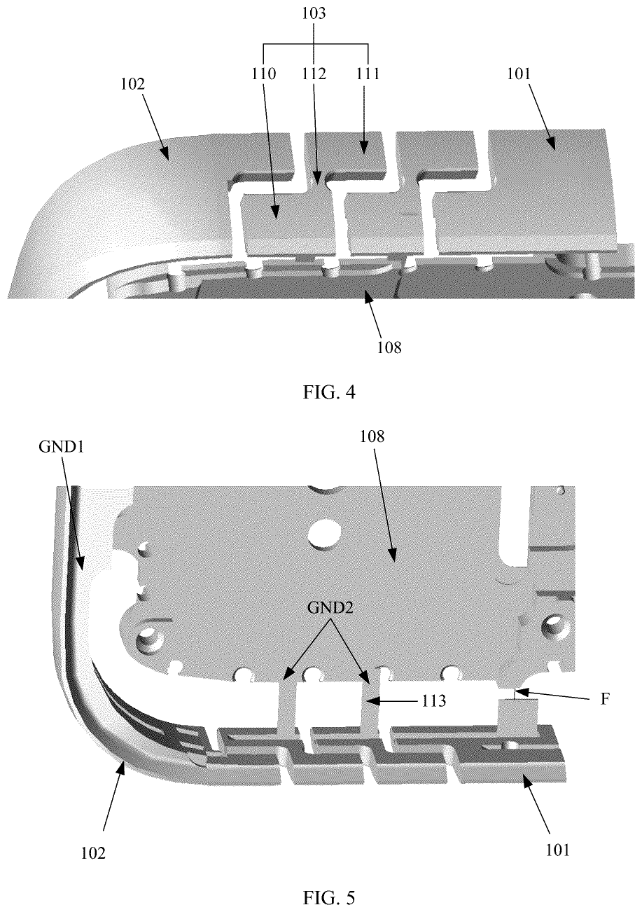

As shown in FIG. 4 and FIG. 5, FIG. 4 illustrates a schematic structural diagram of the target antenna of FIG. 3 in another view angle. FIG. 5 illustrates a schematic structural diagram of the target antenna of FIG. 3 in another view angle. The third radiator 103 includes a first structure 110, a second structure 111, and a connection structure 112. The connection structure 112 is connected to the first structure 110 and the second structure 111. The first structure 110 is on a first side of the connection structure 112. The second structure 111 is on a second side of the connection structure 112.

In the same third radiator 103, the first structure 110, the second structure 111, and the connection structure 112 can be an integrated structure. Based on a graphic structure arranged at the third radiator 103, the third radiator 103 can generate a good resonant effect at the first frequency and the second frequency corresponding to the target antenna.

In embodiments of the present disclosure, when a plurality of third radiators 103 are provided, in the target antenna 100, a plurality of the first structures 110 can be provided and arranged sequentially at an interval. Neighboring first structures 110 can have a slit. A plurality of second structures 111 can be provided and arranged sequentially at an interval. Neighboring second structures 111 can have a slit.

Among different third radiators 103, the first structures 110 can be arranged sequentially at an interval, and the second structures 111 can be arranged sequentially at an interval. Thus, the third radiators 103 each can generate resonance to form an antenna structure having a plurality of resonances. Then, the target antenna can generate good radiation performance at the first frequency and the second frequency.

In connection with FIG. 2 and FIG. 3, the third radiator 103 further includes a third structure 113. The first end of the third structure 113 is connected to the connection structure 112. A second end of the third structure 113 is connected to the plate 108 representing ground. The surface where the third structure 113 is located intersects with the surface where the first structure 110 and the second structure 111 are. The third radiator 103 can be connected to the plate 108 representing ground through the third structure 113. Thus, the third radiators 103 each can be connected to the plate 108 representing ground based on a separate third structure 113. Then, the third radiators 103 each can correspond to a resonant structure to form the antenna structure with a plurality of resonances. Thus, the target antenna can generate a good radiation performance at the first frequency and the second frequency.

In some embodiments, the first structure 110 and the second structure 111 can be arranged on the first surface, and the third structure 113 can be arranged on the second surface. The first surface can be perpendicular to or nearly perpendicular to the second surface.

In addition, for the third radiator 103, since the connection structure 112 is connected to the plate 108 representing ground through the third structure 113, the part of the third radiator 103 on the first surface can be uniformly distributed on two sides of the third structure 113, which is beneficial to maintain the stability of the third structure 113 and ensure the third radiator 103 to form a good resonant effect. The third structure 113 can also support the first structure 110, the second structure 111, and the connection structure 112 above the third structure 113 to ensure the structural strength of the third radiator 103.

Based on the above, the third radiator 103 can at least include the first structure 110, the second structure 111, and the connection structure 112. The first structure 110 can be arranged on the first side of the connection structure 112, and the second structure 111 can be arranged on the second side of the connection structure 112. That is, the first radiator 101 and the second radiator 102 can be in the direction of the connection line. The first structure 110 and the second structure 111 can be arranged on two sides of the connection structure 112.

The two neighboring radiators in the direction of the connection line of the first radiator 101 and the second radiator 102 can have an overlapped portion. As shown in FIG. 3 and FIG. 4, in the direction of the connection line, the first radiator 101 and the second radiator 102 have overlapped portions with the third radiator 103 in the direction of the connection line. The neighboring third radiators 103 have an overlapped portion. In the direction perpendicular to the connection line, for any one third radiator 103, the first structure 110 of the third radiator 103 can have an overlapped portion with the neighboring radiator. The second structure 111 of the third radiator 103 has an overlapped portion with the neighboring radiator. Thus, the first side and the second side of the third radiator can form overlapped portions with other neighboring radiators in the direction perpendicular to the connection line.

Based on the above description, in the electronic device of embodiments of the present disclosure, the two neighboring radiators can have an overlapped portion in the direction of the connection line and an overlapped portion in the direction perpendicular to the connection line. Then, the resonant structure can be formed in the target antenna 100 based on the third radiator 103 to increase the resonance of the target antenna 100 to broaden the bandwidth and reduce the volume of the radiator.

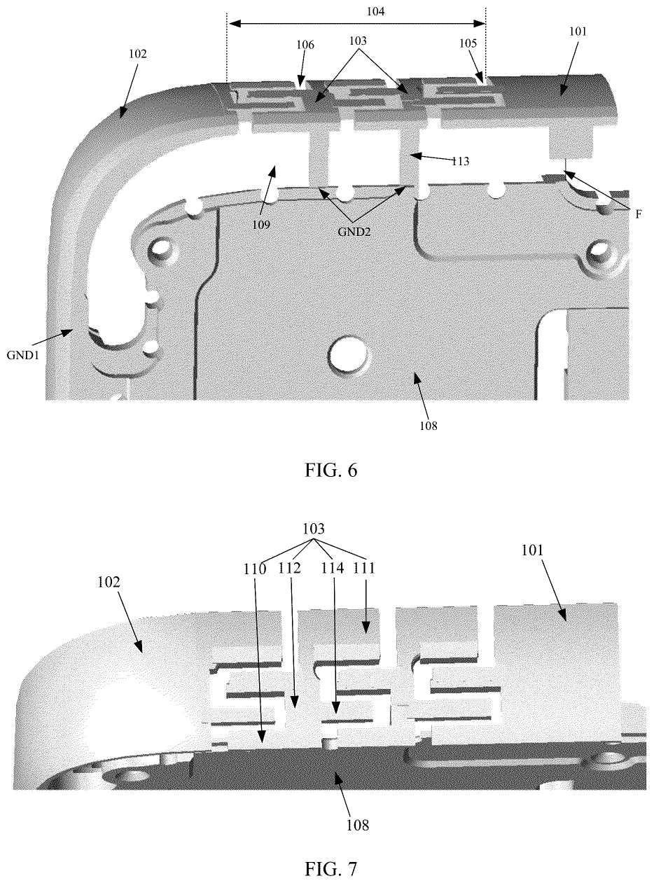

In embodiments of the present disclosure, based on a first frequency band RF signal and a second frequency band RF signal that need to be received and transmitted by the target antenna 100, the third radiator 103 matching the graphic structure can be provided. The target antenna 100 is not limited to the manner shown in FIG. 2 to FIG. 5, e.g., can include the manner shown in FIG. 6 to FIG. 8.

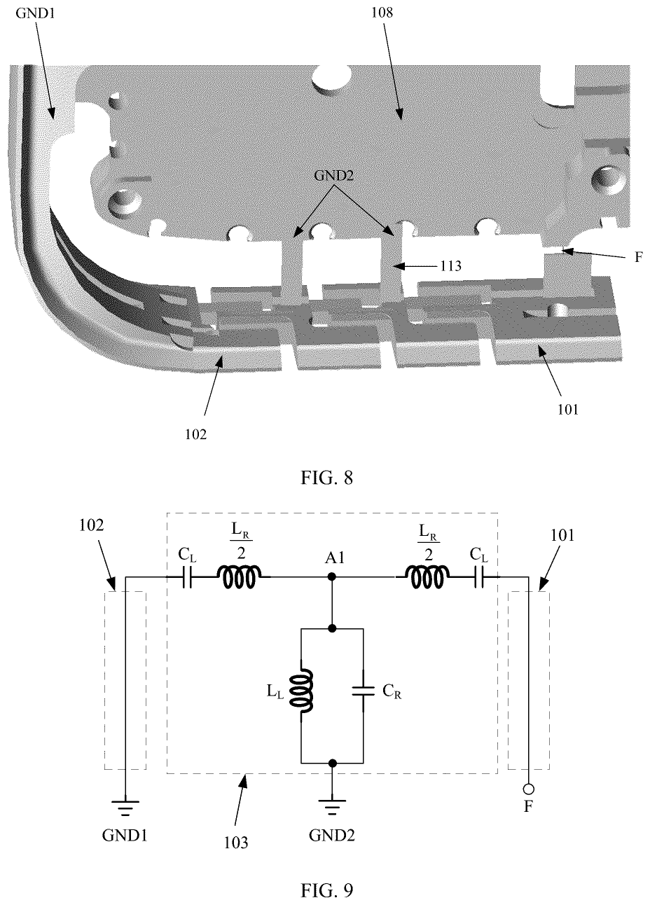

As shown in FIG. 6 to FIG. 8, FIG. 6 illustrates a schematic structural diagram of a target antenna in a first view angle according to some embodiments of the present disclosure. FIG. 7 illustrates a schematic structural diagram of a target antenna in a second view angle according to some embodiments of the present disclosure. FIG. 8 illustrates a schematic structural diagram of a target antenna in a third view angle according to some embodiments of the present disclosure. In some embodiments, the third radiator 103 further includes a fourth structure 114. In the direction of the connection line of the first radiator 101 and the second radiator 102, two opposite sides of the connection structure 112 each can be connected to a fourth structure 114. The fourth structure 114 can be on the same plane with the first structure 110, the second structure 111, and the connection structure 112.

As shown in FIG. 6 to FIG. 8, the first gap 104 is divided into the plurality of slits by the third radiator 103. Based on the fourth structure 114, the lengths of the slits can be longer, and the length of the third radiator 103 can be longer. Thus, a larger equivalent inductor and capacitor can be formed, and the coupling function between neighboring radiators can be stronger.

In the electronic device of embodiments of the present disclosure, at least one third radiator 103 can be arranged between the first radiator 101 and the second radiator 102. Based on the third radiator 103, the first gap 104 between the first radiator 101 and the second radiator 102 can be divided into a plurality of slits.

In the target antenna 100, the first gap 104 can be divided into the plurality of slits by the third radiator 103. In the direction of the connection line of the first radiator 101 and the second radiator 102, a third radiator 103 is correspondingly arranged between two neighboring slits. That is, the two opposite sides of the third radiator 103 each can have a slit in the direction. Each slit can form a first capacitor C_{L} connected in the circuit connecting between the first radiator 101 and the second radiator 102. The third radiator 103 can be equivalent to a first inductor L_{R} connected in the circuit connecting between the first radiator 101 and the second radiator 102. Since the third radiator 103 is connected to the plate 108 representing ground based on the second ground point GND2, the third radiator 103 can be further equivalent to the second inductor L_{L} connected to the second ground point GND 2. The third radiator can further be equivalent to a second capacitor C_{R} connecting between the second ground points GND2 based on the second gap 109 between the third radiator 103 and the plate 108 representing ground.

Based on the plurality of third radiators 103 having the same structures, the first gap 104 can be divided into a plurality of slits having the same structures. The third radiators 103 with different graphic structures can divide the first gap 104 into the slits with different structures. The third radiators 103 with different structures can realize the slits with different lengths and the third radiators with different lengths. The first inductor L_{R} and the second inductor L_{L} can be related to the lengths of the third radiators 103. The first capacitor C_{L} and the second capacitor C_{R} can have the same length as the slits of the first gap 104.

For the same third radiator 103, the second gap 109 between the third radiator 103 and the plate 108 representing ground can form the second capacitor C_{R}. Since the third radiator 103 and the plate 108 represent ground, each can be equivalent to a capacitor electrode plate of the second capacitor C_{R}. The third structure 113 arranged between the third radiator 103 and the plate 108 representing ground can be a stripe metal structure with a small size (i.e., as shown in FIG. 5, the stripe metal structure is a wall extending toward the plate 108 representing ground not corresponding to the maximum width of the third radiator 103, and only correspond to a part of the third radiator 103). Since the third radiators 103 does not divide the second gap 109 between the third radiator 103 and the plate 108 representing ground into two independent slits, and the second gap 109 is still an integral gap structure around the third radiator 103, the third radiator 103 and the plate 108 representing ground can be equivalent to a capacitor.

Based on the equivalent relationship, when the third radiator 103 is arranged between the first radiator 101 and the second radiator 102, the equivalent circuit of the target antenna 100 is shown in FIG. 9.

FIG. 9 illustrates a schematic equivalent circuit diagram of the target antenna according to some embodiments of the present disclosure. The third radiator 103 forms the first inductor L_{R} based on the first structure 110, the second structure 111, and the connection structure 112. The N+1 slits corresponding to the first gap 104 form one first capacitor C_{L}. The first inductor L_{R} and the first capacitor C_{L} are connected in serial in the circuit between the first radiator 101 and the second radiator 102. The third radiator 103 forms the second inductor L_{L} based on the third structure 113. The third radiator 103 forms the second capacitor based on the second gap 109. The second inductor L_{L} and the second capacitor C_{R} are connected in parallel between the circuit node A1 between the first radiator 101 and the second radiator 102 and the second ground point GND2.

In some embodiments, as shown in FIG. 9, the third structure 113 is at the center point of the connection structure 112. Then, the first inductor L_{R} is equally divided into two portions connected to two sides of the circuit point A1, respectively. The circuit node Al is an equivalent position of the connection point of the third structure 113 and the connection structure 112 at the circuit between the first radiator 101 and the second radiator 102.

As shown in FIG. 9, when a third radiator 103 is arranged between the first radiator 101 and the second radiator 102, the third radiator 103 divides the first gap 104 into two slits. Each slit corresponds to a first capacitor C_{L}. Based on the position of the circuit node A1, the first inductor L_{R} can be equally divided into two portions. Each portion is L_{R}/2. Thus, a capacitor L_{R}/2 is connected between each first capacitor C_{L} and the circuit node A1. The third radiator 103 is grounded based on the third structure 113, which can be equivalent to a second inductor L_{L} being connected between the circuit node A1 and the second ground point GND2. A second capacitor C_{R} is formed between the third radiator 103 based on the second gap 109 and the plate 108 representing ground. In the same third radiator 103, the second inductor L_{L} and the second capacitor CR are connected in parallel between the circuit node A1 and the second ground point GND2.

Based on the equivalent circuit shown in FIG. 9, based on the third radiator 103, an L_{C} circuit connected in serial is formed in the circuit between the first radiator 101 and the second radiator 102. Another L_{C} circuit is formed between the circuit node point A1 corresponding to the third radiator 103 and the second ground point GND2. That is, a plurality of resonances can be introduced into the same third radiator 103 to cause the antenna to have more resonances. Then, the effective bandwidth of the target antenna 100 can be expanded. The equivalent circuit structure shown in FIG. 9 satisfies the feature of the left hand transmission line to further reduce the size of the overall radiator of the target antenna 100. Since the feature of the left hand transmission line has a relatively small loss, the radiation performance of the target antenna can be better.

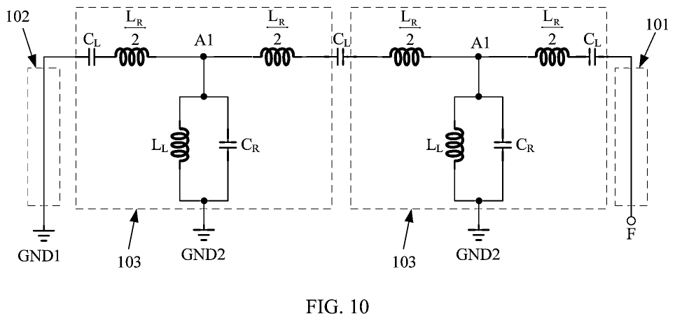

Based on the above equivalent relationship, when two third radiators 103 are arranged between the first radiator 101 and the second radiator 102, the equivalent circuit of the target antenna 100 is shown in FIG. 10.

FIG. 10 illustrates a schematic equivalent circuit diagram of another target antenna according to some embodiments of the present disclosure. Based on the above, in embodiments of the present disclosure, the third radiators 103 have the same structure. Thus, when two third radiators 103 are provided in the target antenna, the two third radiators 103 can have the same equivalent structure in the equivalent circuit of the target antenna 100. Then, since a shared slit is formed between the two third radiators 103, a shared first capacitor C_{L} is formed between the equivalent circuits of two neighboring third radiators 103. The circuit node points A1 corresponding to the different third radiator 103 can be different circuit node points of the circuit between the first radiator 101 and the second radiator 102.

Based on FIG. 10, when two third radiators 103 are provided, each third radiator 103 is configured to introduce a plurality of L_{C} circuits into the equivalent circuit of the target antenna 100. Thus, the target antenna 100 can generate more resonances.

The equivalent circuit shown in FIG. 10 can be an equivalent circuit of a left-right hand input to form a left-right hand resonant unit structure. Then, the overall radiator of the target antenna can be miniatured. Based on the plurality of resonances, the target antenna 100 can have a better radiation performance.

In a general antenna design, the multiple frequency bands operation capability can be realized in the same antenna through an antenna switch or a tuner. The circuit structure can be complex, the cost of the product can be high, the circuit tuning can be complex, and the antenna performance can be poor.

In embodiments of the present disclosure, based on the communication performance at the first frequency and the second frequency required by the antenna 100, the target antenna 100 can include one or a plurality of third radiators 103. One, two, or three third radiators 103 can be provided. The value of N is not limited in embodiments of the present disclosure. When N is larger, the bandwidth expansion effect can be larger, and the size of the overall radiator of the target antenna 100 can be smaller.

Based on the above description, in the electronic device of embodiments of the present disclosure, through the third radiator 103 that is configured to improve the resonant performance of the target antenna 100, the bandwidth of the target antenna 100 can be improved, and the size of the radiator of the target antenna 100 can be effectively reduced. Thus, the space taken by the radiator of the target antenna 100 can be reduced. With the larger bandwidth, the target antenna 100 can operate at a plurality of frequency bands, and the radiation performance may not deteriorate.

In some embodiments, the radiator of the target antenna 100 can be a part of a metal frame of the electronic device. The part of the metal frame can be reused as the first radiator 101, the second radiator 102, and the third radiator 103. The third radiators 103 can divide the first gap 104 into a plurality of slits, which can be used as at least one of a sound output hole and a heat dissipation hole of the electronic device. Then, the plurality of slits formed by the third radiators 103 dividing the first gap 104 can be configured to realize the multi-resonance function for the target antenna, and the sound outlet hole and/or the heat dissipation hole can be reused without separately forming a sound outlet hole and/or a heat dissipation hole. That is, the reused sound outlet hole and/or the heat dissipation hole can be slits configured to realize the multi-resonance function. The existing hole structure of the electronic device can be compatible and can be used to form the slits for realizing the multi-resonance function of the target antenna.

When the first gap is divided by the third radiators 103 into the plurality of slits being used as at least one of the sound outlet hole and the heat dissipation hole of the electronic device, the sizes of the sound outlet hole and/or the heat dissipation hole can be increased when large slits are required to realize the first frequency and the second frequency of the plurality of resonance function of the target antenna 100. Then, the electronic device can be facilitated to perform heat dissipation and sound output.

In the electronic device of embodiments of the present disclosure, based on the equivalent circuit, the multi-resonance function of the target antenna can be realized based on the third radiators 103. Thus, the bandwidth of the target antenna 100 can be effectively increased to cause the target antenna 100 to simultaneously support the RF signal of the first frequency and the RF signal of the second frequency.

In connection with experiment data, the performance of the target antenna 100 of the electronic device of embodiments of the present disclosure can be further described.

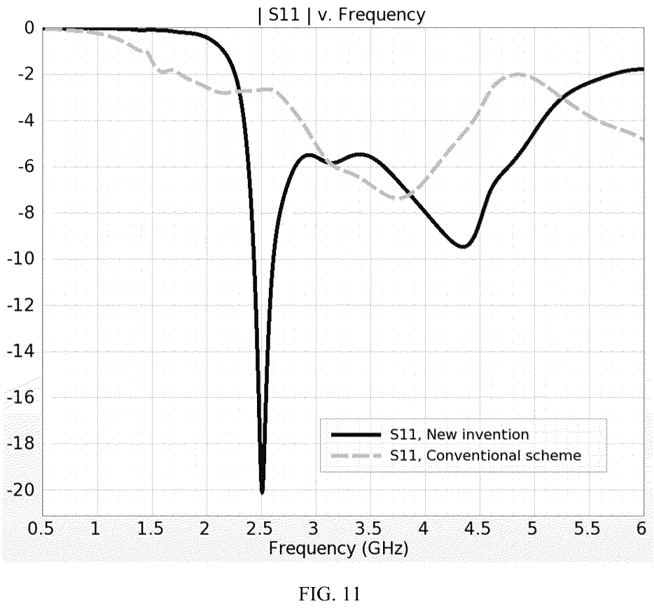

FIG. 11 illustrates a schematic diagram showing a return wave loss of a target antenna according to some embodiments of the present disclosure. As shown in FIG. 11, the dashed line represents a return wave loss curve of the antenna with the whole metal segment as the radiator in the existing technology. The solid line represents a return wave loss curve when the whole metal segment is prepared as the target antenna including the third radiators in embodiments of the present disclosure. The horizontal axis represents the frequency with a unit GHz, and the vertical axis represents return wave loss with a unit dB.

The frequency band with a return wave loss of the antenna under −4 dB can be a frequency band satisfying the wireless communication requirement. The dashed line represents that the effective communication bandwidth of the general antenna ranges from 2.8 GHz to 5.5 GHz when the return wave loss of the antenna is under −6 dB, and the bandwidth is 1.7 GHz. The solid line can represent that the effective communication bandwidth of the target antenna ranges from 2.4 GHz to 5.1 GHz when the return wave loss is under −6 dB, and the bandwidth can be 2.7 GHZ.

The solid line shows that the return wave loss of the target antenna is very small at 2.5 GHz and 4.4 GHz. Thus, a good radiation efficiency can be realized at the two frequencies.

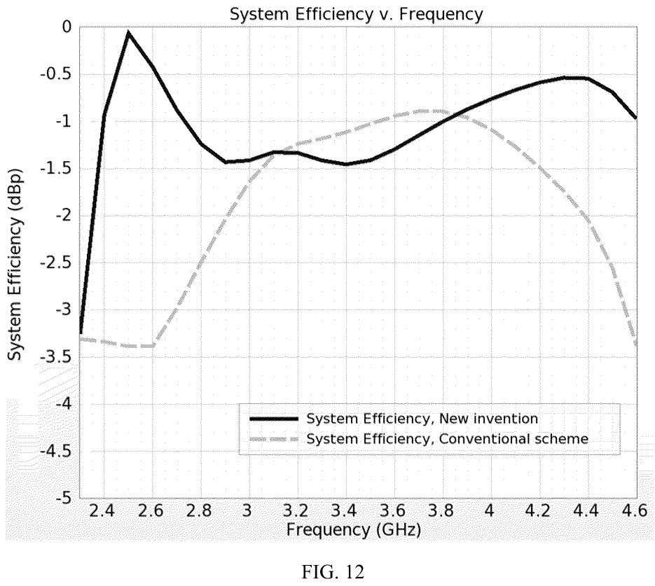

FIG. 12 illustrates a schematic diagram showing radiation efficiency of a target antenna according to some embodiments of the present disclosure. As shown in FIG. 12, the dashed line curve represents the radiation efficiency curve of the antenna corresponding to the dashed line in FIG. 11. The solid line curve represents the radiation efficiency curve of the antenna corresponding to the solid line in FIG. 11. The horizontal axis represents the frequency with a unit of GHz, and the vertical axis represents the antenna radiation efficiency with a unit of dBp.

In the antenna radiation efficiency diagram, when the value on the vertical axis is larger, the radiation efficiency of the antenna at the corresponding frequency can be stronger. Based on FIG. 12, the target antenna has a maximum value at the two frequencies of 2.5 GHz and 4.4 GHz. That is, based on the target antenna structure of embodiments of the present disclosure, the high radiation efficiencies of the two frequencies can be simultaneously realized.

Embodiments of the present disclosure are described in a progressive manner, parallel manner, or a combination thereof. Each embodiment focuses on the difference different from other embodiments. The same or similar part among embodiments of the present disclosure can be referred to each other.

In the description of the present disclosure, the descriptions of the accompanying drawings and embodiments are illustrative, not limiting. The same mark throughout the specification can identify the same structure. In addition, to facilitate understanding and description, in the accompanying drawings, the thicknesses of some layers, films, panels, and areas can be exaggerated. Meanwhile, when an element such as a layer, a film, an area, or a substrate is referred to as being on another element, the element can be directly or indirectly on another element. In addition, “on” means that the element is positioned above another element, or under another element. However, the essence does not mean that the gravity direction is on the upper side of another element.

In some embodiments, the orientation or position relationship indicated by the terms such as “up,” “down,” “top,” “bottom,” “inside,” “outside,” etc., are the orientation or position relationship shown in the accompanying drawings, which are merely used to facilitate the description of the present disclosure and simplify the description and should not indicate or imply that the apparatus or element must have the specific orientation or be constructed and operated with the specific orientation, which do not limit the present disclosure. When an assembly is considered to be connected to another assembly, the assembly can be directly connected to another assembly, or an assembly can be arranged therebetween.

In the specification, the relationship terms such as first and second are merely used to distinguish one entity or operation from another entity or operation without requiring or implying that any actual relationship or sequence exists among the entities or operations. Moreover, the term “include,” “comprise,” or any other variations are intended to cover non-exclusive inclusion. Thus, a device or article that includes a series of elements is not limited to those elements but can include other elements not expressly listed or elements inherent to such devices or articles. When there is no more limitation, the element is described by the phrase “include one . . . ” does not exclude the presence of additional identical elements in the device or article that includes the element.

The above description of embodiments of the present disclosure can cause those skilled in the art to implement or use the present disclosure. Various modifications to embodiments of the present disclosure are obvious for those skilled in the art. The general principle defined in the specification can be implemented in other embodiments of the present disclosure without departing from the spirit or scope of the present disclosure. Thus, the present disclosure is not limited to embodiments of the present disclosure but should conform to the widest scope consistent with the principle and novel features of the present disclosure.

What is claimed is:

1. An electronic device, comprising a target antenna including:
a first radiator including a feed point;
a second radiator including a first ground point and having a first gap with the first radiator;
a third radiator including a second ground point, located in the first gap between the second radiator and the first radiator, and dividing the first gap into a first slit and a second slit;
a transceiver connected to the feed point; and
a plate representing ground connected to the first ground point and the second ground point;
wherein the target antenna supports a radio frequency (RF) signal of a first frequency and an RF signal of a second frequency, and the first frequency is different from the second frequency.

2. The electronic device of claim 1, wherein the third radiator has a second gap with the plate representing ground.

3. The electronic device of claim 2, wherein:
a structure of the first radiator on a side of the first slit matches a structure of the third radiator on the side of the first slit, and the first slit is a non-straight-line structure; and
a structure of the second radiator on a side of the second slit matches a structure of the third radiator on the side of the second slit, and the second slit is a non-straight-line structure.

4. The electronic device of claim 3, wherein:
the target antenna includes N third radiators, N being a positive integer;
in response to N being greater than 1, the N third radiators have a same structure, are arranged sequentially, divide the first gap into N+1 slits, and each has a second gap with the plate representing ground.

5. The electronic device of claim 4, wherein the third radiator includes at least:
a first structure;
a second structure; and
a connection structure connected to the first structure and the second structure, the first structure being located on a first side of the connection structure and the second structure being located on a second side of the connection structure.

6. The electronic device of claim 5, wherein:
a plurality of first structures are provided and arranged sequentially at an interval; and
a plurality of second structures are provided and arranged sequentially at an interval.

7. The electronic device of claim 6, wherein the third radiator further includes:
a third structure, a first end of the third structure being connected to the connection structure, and a second end of the third structure being connected to the plate representing ground; and
a surface where the third structure is located intersects with a surface where the first structure and the second structure are located.

8. The electronic device of claim 7, wherein:
the third radiator forms a first inductor based on the first structure, the second structure, and the connection structure;
the N+1 slits corresponding to the first gap each forms a first capacitor, and the first inductor and the first capacitor are connected in series in a circuit between the first radiator and the second radiator;
the third radiator forms a second inductor based on the third structure; and
the third radiator forms a second capacitor based on the second gap, and the second inductor and the second capacitor are connected in parallel between a circuit node between the first radiator and the second radiator and the second ground point.

9. The electronic device of claim 1, wherein:
radiators of the target antenna are a part of a metal frame of the electronic device; and
a plurality of slits formed by the third radiator dividing the first gap are used for at least one of a sound output hole or a heat dissipation hole of the electronic device.

10. The electronic device of any of claim 1, wherein the target antenna simultaneously supports the RF signal of the first frequency and the RF signal of the second frequency.
